(19) United States
(12) Patent Application Publication
(10) Pub. No.: US 2021/0360872 A1
(43) Pub. Date: Nov. 25, 2021

(54) Cultivating Apparatus

(71) Applicant: eFarm Global Agri Technology Limited, Taichung City (TW)

(72) Inventor: Yu-Feng Tai, Taichung City (TW)

(21) Appl. No.: 16/880,030

(22) Filed: May 21, 2020

(51) Int. Cl. A01G 9/24; A01G 18/69; A01G 9/26; A01G 18/62

(52) U.S. Cl. CPC A01G 9/246; A01G 18/69; A01G 18/62; A01G 9/26; A01G 9/249; A01G 9/247

(57) ABSTRACT

A cultivating apparatus includes a carrier, a fresh air supply, a humidifying mechanism, an illuminating mechanism, a blower mechanism, a sterilizing pool and a controlling mechanism. The fresh air supply, the humidifying mechanism, the illuminating mechanism, the blower mechanism, the sterilizing pool and the controlling mechanism are inserted in or supported on the carrier. Thus, the cultivate apparatus is movable and operable to control temperature, humidity, air quality and irradiation for cultivating of plants or mushrooms.

### BACKGROUND OF INVENTION

### 1. Field of Invention

The present invention relates to cultivation of plants and mushrooms, more particularly, to a cultivating apparatus for plants and mushrooms.

### 2. Related Prior Art

In agriculture, the cultivation of plants such as vegetables and mushrooms are vulnerable to the weather and environment. Yields can be reduced or polluted due to problems in the weather or environment. To overcome these problems, screen-houses and greenhouses are built to isolate plants or mushrooms from external environments.

The screen-houses and greenhouses are handy in providing isolated farms. However, the use of the screen-houses or greenhouses is not without any problems.

Firstly, buildings are not allowed in some agricultural land or farmland. In such a case, a screen house or greenhouse cannot be built.

Secondly, a screen-house or greenhouse is structurally weak and hence does not stand strong wind in extreme weathers.

Thirdly, the location of a screen-house or greenhouse is fixed and hence the screen-house or green house cannot be moved from one place to another to avoid pollution or natural disasters such as floods.

Fourthly, a screen-house or greenhouse can be transported from one place to another only after it is taken apart. Hence, the screen-house or green house cannot be used to cultivate plants or mushrooms during the transportation.

Fifthly, a screen-house or greenhouse can only be used to cultivate types of plants or mushrooms in season due to seasonal changes in the weather and irradiation. Hence, a screen-house or greenhouse cannot be used to cultivate types of plants or mushrooms out of season. Hence, oversupply or undersupply is inevitable.

The present invention is therefore intended to obviate or at least alleviate the problems encountered in prior art.

### SUMMARY OF INVENTION

It is the primary objective of the present invention to provide a movable and reliable cultivating apparatus.

To achieve the foregoing objective, the cultivating apparatus includes a carrier, a fresh air supply, a humidifying mechanism, an illuminating mechanism, a blower mechanism, a sterilizing pool and a controlling mechanism. The carrier includes a shell, a partition, a partition door, a front door, and a lateral door. The partition is inserted in the shell to divide a space in the shell into a control region and a cultivating region. The partition door is pivotally connected to the partition and operable to open or cut communication of the control region with the cultivating region. The front door is pivotally connected to a front wall of the shell and operable to open or cut communication of the cultivating region with exterior of the shell. The lateral door is pivotally connected to a lateral wall of the shell and operable to open or cut communication of the control region with the exterior of the shell. The fresh air supply includes an air filter, a fresh air fan and a heat exchanger. The air filter is supported on a lateral wall of the shell so that the exterior of the shell is in communication with the control region via the air filter. The fresh air fan is in communication with the air filter at an end and in communication with the cultivating region at another end and operable to transmit fresh air into the cultivating region from the exterior of the shell. The heat exchanger is supported on the shell and operable to exchange heat with the cultivating region. The humidifying mechanism includes a water tank, a humidifier, sprinklers and a water pump. The water tank is inserted in the control region in the shell. The humidifier is inserted in the control region in the shell, in communication with the water tank at an end, in communication with the cultivating region at another end, and operable to provide humidifying air. The sprinklers are inserted in the cultivating region in the shell. The water pump is inserted in the control region in the shell (11), in communication with the water tank at an end, and in communication with the sprinklers at another end. The illuminating mechanism includes at least one first light source inserted in the cultivating region in the shell and operable to emit first light. The controlling mechanism includes at least one thermometer, at least one humidity sensor, at least one air sensor and a monitoring host. The thermometer is inserted in the cultivating region in the shell, and operable to detect a value of temperature in the cultivating region. The humidity sensor is inserted in the cultivating region in the shell, and operable to detect a value of humidity in the cultivating region. The air sensor is inserted in the cultivating region in the shell, and operable to detect a value of air quality in the cultivating region. The monitoring host is electrically connected to the thermometer, the humidity sensor, the air sensor, the fresh air fan, the heat exchanger, the water pump and the first light source, and operable to actuate the water pump, the fresh air fan, the heat exchanger, the humidifier and the first light source according to predetermined values of the temperature, humidity and air quality.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a cultivating apparatus according to the first embodiment of the present invention;

FIG. 2 is another perspective view of the cultivating apparatus shown in FIG. 1;

FIG. 3 is a cut-away view of the cultivating apparatus shown in FIG. 1;

FIG. 4 is another cut-away view of the cultivating apparatus of FIG. 1;

FIG. 5 is an enlarged partial and cut-away view of the cultivating apparatus shown in FIG. 1;

FIG. 6 is a cross-sectional view of the cultivating apparatus taken along a line I-I shown in FIG. 1;

FIG. 7 is an enlarged partial view of the cultivating apparatus shown in FIG. 6;

FIG. 8 is another enlarged partial view of the cultivating apparatus shown in FIG. 6;

FIG. 9 is a cross-sectional view of the cultivating apparatus taken along a line II-II shown in FIG. 6;

FIG. 10 is a cross-sectional view of the cultivating apparatus taken along a line shown in FIG. 6;

FIG. 11 is a perspective of a shelf inserted in the cultivating apparatus shown in FIG. 3;

FIG. 12 is a block diagram of a control module of the cultivating apparatus shown in FIG. 3;

FIG. 13 is a cut-away view of a cultivating apparatus according to the second embodiment of the present invention;

FIG. 14 is an enlarged partial view of the cultivating apparatus shown in FIG. 13;

FIG. 15 is an enlarged partial and cut-away view of the cultivating apparatus shown in FIG. 13, containing two shelfs;

FIG. 16 is an enlarged perspective view of a vehicle of the cultivating apparatus shown in FIG. 15;

FIG. 17 is a cut-away view of a cultivating apparatus according to the third embodiment of the present invention; and

FIG. 18 is an enlarged partial view of the cultivating apparatus shown in FIG. 17.

### DETAILED DESCRIPTION OF EMBODIMENTS

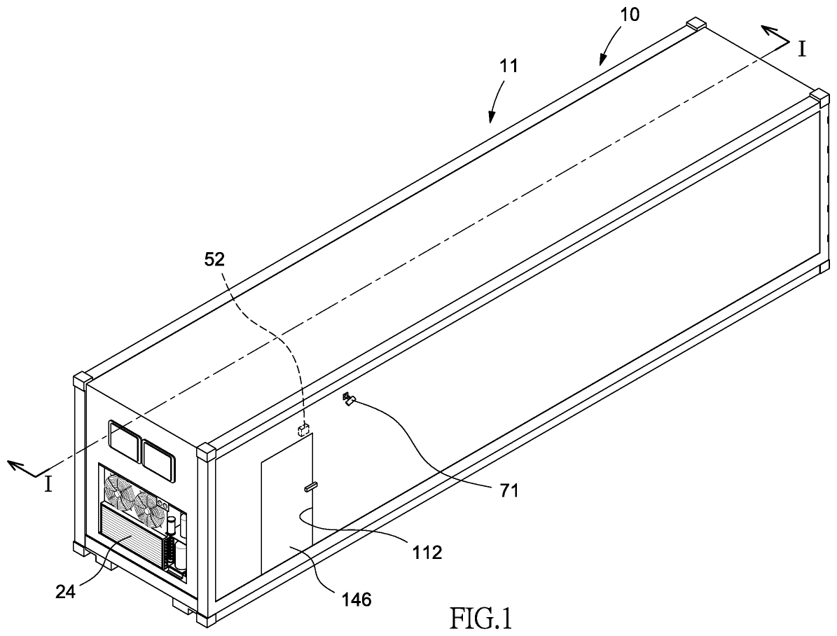

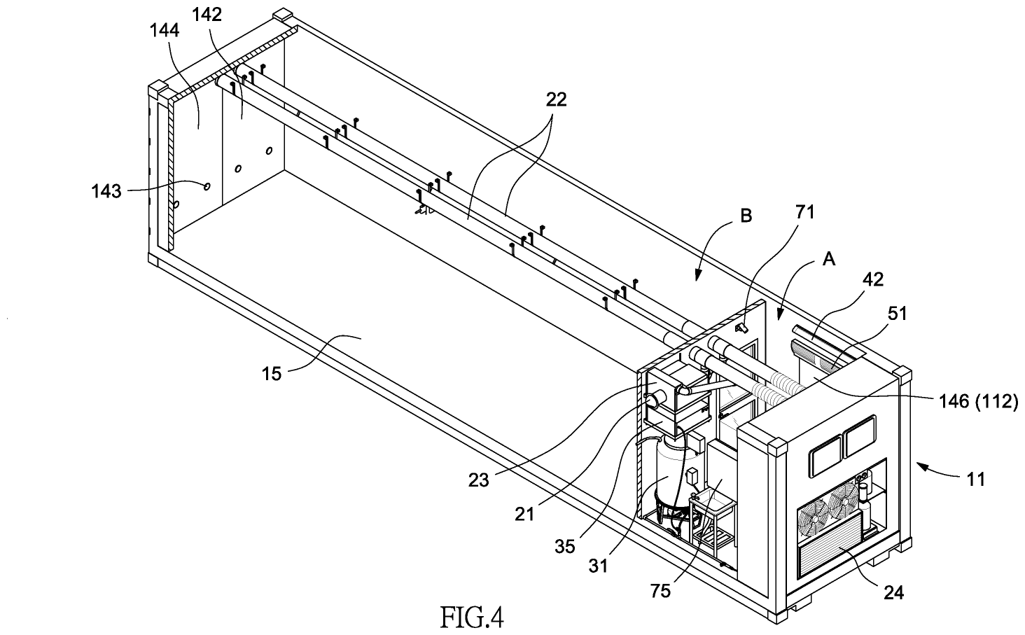

Referring to FIGS. 1 through 12, a cultivating apparatus includes a carrier 10, a fresh air supply (not numbered), a humidifying mechanism (not numbered), an illuminating mechanism (not numbered), a blower mechanism (not numbered), a sterilizing pool 60 and a controlling mechanism (not numbered) according to a first embodiment of the present invention.

Referring to FIGS. 1 to 5, the carrier 10 includes a shell 11, a partition 12, a partition door 13, two front doors 142 and 144, a lateral door 146 and a horizontal plate 15.

The shell 11 can be made of a standard container for shipment. Preferably, the size of the shell 11 is 20×40×40 feet. The shell 11 includes a roof (not numbered), a floor (not numbered), a front wall (not numbered), a rear wall (not numbered) and two lateral walls (not numbered).

The lateral entrance 112 is made in one of the lateral walls of the shell 11. The lateral entrance 112 is in communication with a space in the shell 11.

A front entrance 114 is made in the front wall of the shell 11. The front entrance 114 is in communication with the space in the shell 11.

The partition 12 is inserted in the shell 11, thereby dividing the space in the hell 11 into a control region A and a cultivating region B. The partition 12 includes a partition entrance 122 through which the control region A is in communication with the cultivating region B. The lateral entrance 112 allows access to the control region A. The front entrance 114 allows access to the cultivating region B.

The partition door 13 is pivotally connected to the partition 12. The partition door 13 is operable to close the partition entrance 122.

Each of the front doors 142 and 144 is pivotally connected to a front wall of the shell 11. Each of the front doors 142 and 144 is pivoted independent of the other to close the front entrance 114. Each of the front doors 142 and 144 includes at least one aperture 143. Each of the front doors 142 and 144 preferably includes several apertures 143. The space in the shell 11 (the cultivating region B) is in communication with the exterior of the shell 11 via the apertures 143. Each of the apertures 143 is covered with a filter or screen (not shown).

The lateral door 146 is pivotally connected to a lateral wall of the shell 11. The lateral door 146 is used to close the lateral entrance 112.

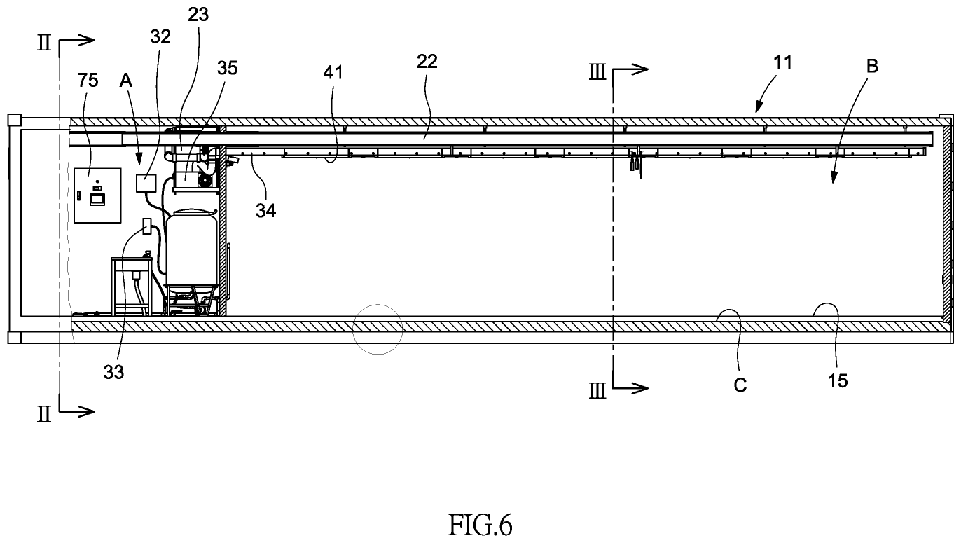

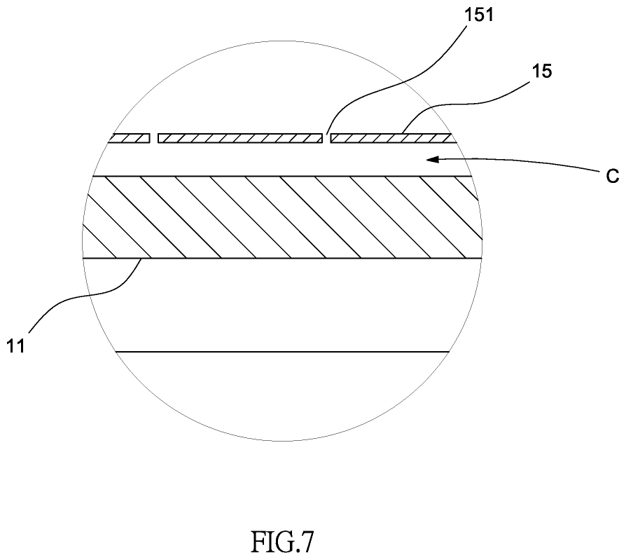

Referring to FIGS. 6 and 7, the horizontal plate 15 and the lower portions of the front, rear and lateral walls of the shell 11 together define at least one drain region C. A portion of the horizontal plate 15 in the cultivating region B is formed with several sinkholes 151. The cultivating region B is in communication with the drain region C via the sinkholes 151.

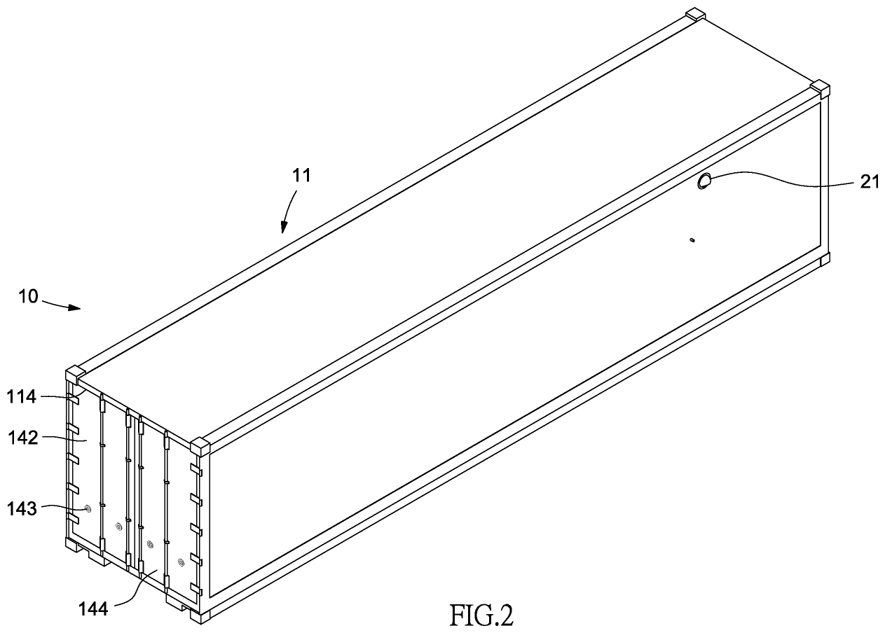

Referring to FIGS. 2 through 9, the fresh air supply includes an air filter 21, at least one fresh air pipes 22, a fresh air fan 23 and a heat exchanger 24.

The air filter 21 is supported on one of the lateral walls of the shell 11 so that the interior of the shell 11 is in communication with the control region A via the air filter 21. Preferably, the air filter 21 is a window provided with a screen.

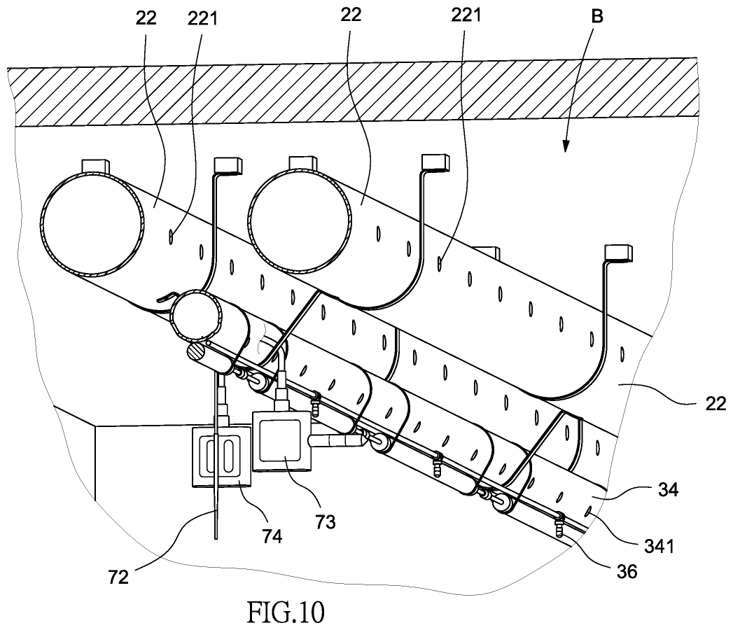

The fresh air pipes 22 are inserted in the shell 11. Each of the fresh air pipes 22 includes a portion in the control region A and another portion in the cultivating region B. Referring to FIG. 10, the portion of each of the fresh air pipes 22 in the cultivating region B is formed with several orifices 221.

The fresh air fan 23 is inserted in the control region A in the shell 11. The fresh air fan 23 is in communication with the air filter 21 and the fresh air pipes 22. Selectively, air is transmitted into the cultivating region B from the exterior of the shell 11 via the air filter 21 and the fresh air pipes 22.

The heat exchanger 24 is supported on an external face of the rear wall of the shell 11. The heat exchanger 24 is connected to the fresh air pipes 22 (not shown) so that heat-exchanging air is transmitted to the fresh air pipes 22 (cultivating region B) from the heat exchanger 24 to keep the air transmitted by the fresh air fan 23 at a predetermined value of temperature.

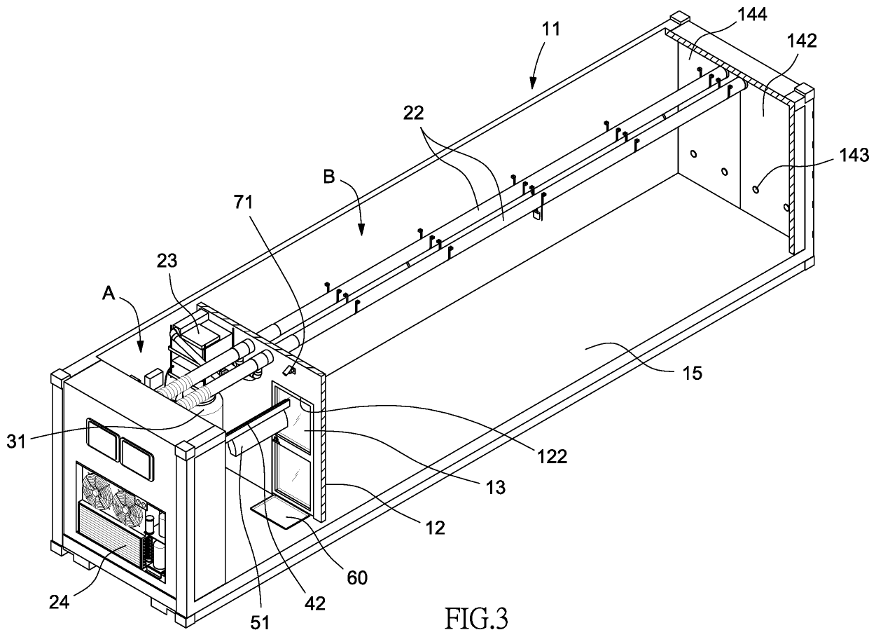

Referring to FIGS. 3 through 10, the humidifying mechanism includes a water tank 31, a water filter 32, a sterilizer 33, at least one humidifying pipe 34, a humidifier 35, several sprinklers 36, a water pump 37, and a hose 38.

The water tank 31 is inserted in the control region A in the shell 11.

The water filter 32 is inserted in the control region A in the shell 11. The water filter 32 is in communication with the water tank 31 at an end and is in communication with an external water source (not shown) at another end. The water filter 32 is actuated by the amount of water contained in the water tank 31 for example to filter water transmitted into the water tank 31 from the external water source. Preferably, the water filter 32 is a reverse osmosis filter.

The sterilizer 33 is in communication with the water tank 31 and is actuated to sterilize the water contained in the water tank 31. The sterilizer 33 is preferably an ozone producer or an ultralight emitter.

The humidifying pipe 34 is inserted in the shell 11 and includes a portion in the control region A and another portion in the cultivating region B. Several humidifying bores 341 are made in the portion of the humidifying pipe 34 in the cultivating region B, arranged along a length of the humidifying pipe 34.

The humidifier 35 is inserted in the control region A in the shell 11. The humidifier 35 is in communication with the water tank 31 at an end and is in communication with the humidifying pipe 34 at another end. The humidifier 35 is actuated by the amount of the water contained in the water tank 31 for example to vibrate the water to provide humidified air. The humidified travels along the humidifying pipe 34 and then goes into the cultivating region B via the humidifying bores 341 to increase the humidity in the cultivating region B.

Referring to FIG. 10, the sprinklers 36 are inserted in the cultivating region B in the shell 11.

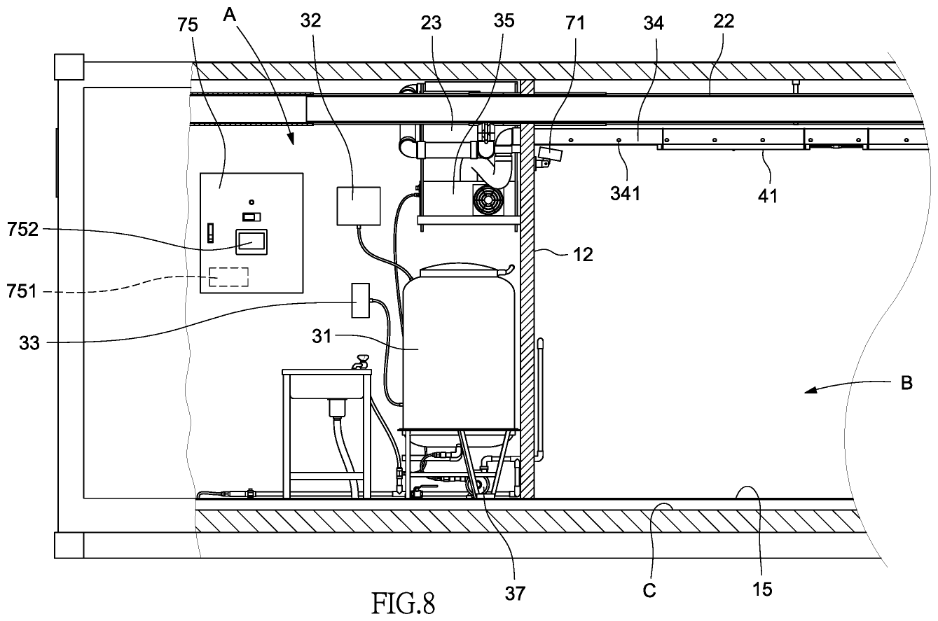

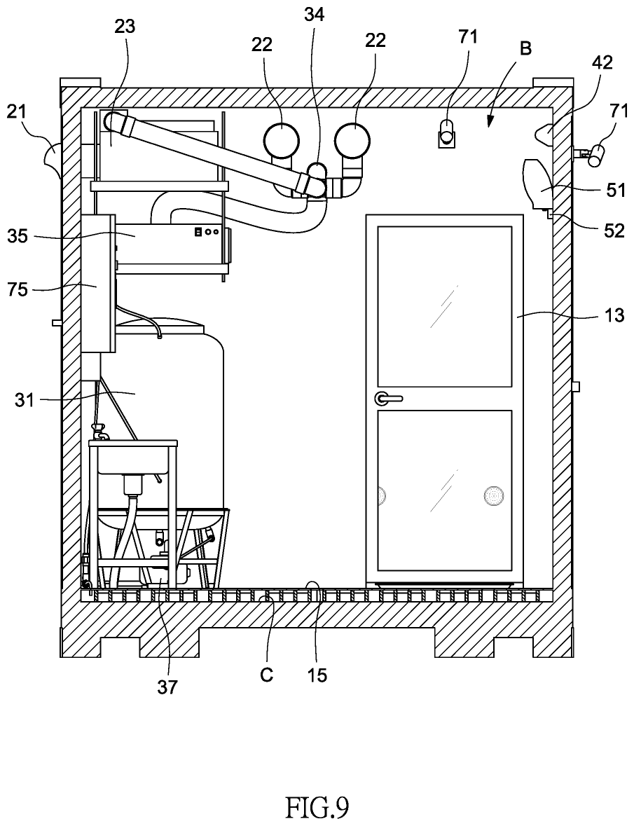

Referring to FIGS. 8 and 9, the water pump 37 is inserted in the control region A in the shell 11. The water pump 37 is in communication with the water tank 31 at an end and is in communication with the sprinklers 36 at another end. Selectively, the water pump 37 is actuated to transmit the water into the sprinklers 36 from the water tank 31. Then, the water leaves the sprinklers 36.

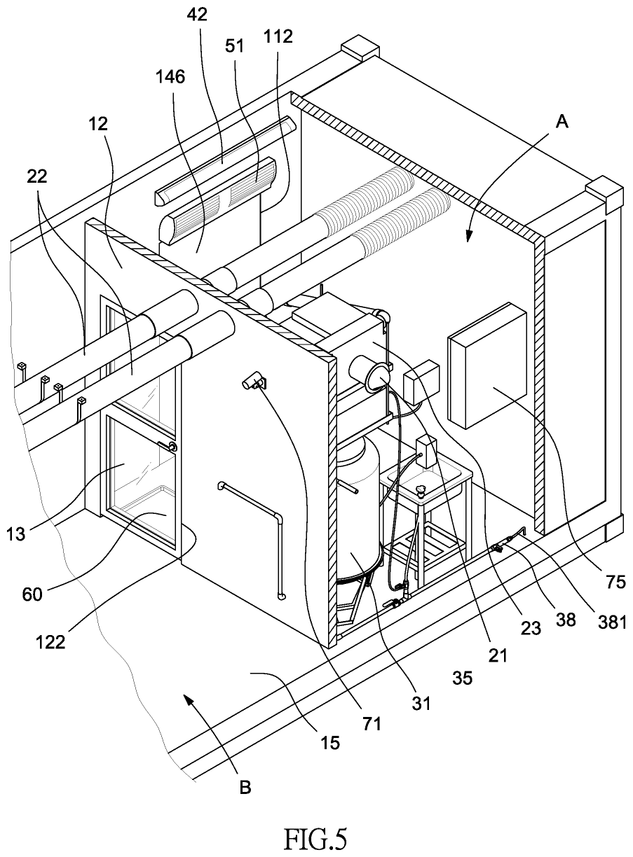

Referring to FIG. 5, the hose 38 is in communication with the water pump 37 at an end and is in communication with the drain region C at another end (not shown). The hose 38 includes a valve 381 operable to open or shut the communication of the hose 38 with the drain region C so that the drain region C can be washed.

Referring to FIGS. 2 through 10, the illuminating mechanism includes a first light source 41 and a second light source 42.

The first light source 41 is inserted in the cultivating region B in the shell 11. The first light source 41 emits first light. The first light preferably stimulates the growth of plants or mushrooms cultivated in the shell 11 or simply illuminates.

The second light source 42 is inserted in the control region A in the shell 11. The second light source 42 is actuated to emit second light. The second light can be identical to or different from the first light.

Referring to FIGS. 1, 3 through 5 and 9, the blower mechanism includes a blower 51 and a sensor 52.

The blower 51 is inserted in the shell 11 corresponding to the lateral entrance 112. The blower 51 is actuated to send wind toward the exterior of the shell 11 through the lateral entrance 112.

Referring to FIG. 1, the sensor 52 is inserted in the shell 11 corresponding to the lateral entrance 112. The sensor 52 is actuated by opening the lateral door 146.

Referring to FIGS. 3 and 5, the sterilizing pool 60 is located at the portion of the horizontal plate 155 (or the floor of the shell 11) in the control region A corresponding to the partition door 13. Preferably, the sterilizing pool 60 is a tray or tank for containing sterilizing liquid.

Referring to FIGS. 1, 4 through 10 and 12, the controlling mechanism includes at least one camera 71, at least one thermometer 72, at least one humidity sensor 73, at least one air sensor 74 and a monitoring host 75.

Preferably, several cameras 71 are supported on the shell 11. Some of the cameras 71 are located in the shell 11. The other cameras 71 are located out of the shell 11.

Referring to FIG. 10, preferably, a thermometer 72 is inserted in the cultivating region B in the shell 11, another thermometer 72 is inserted in the control region A, and still another thermometer 72 is supported on the external face of the shell 11. Thus, values of temperature in the control region A and the cultivating region B and out of the shell are detected.

Referring to FIG. 10, preferably, there is a humidity sensor 73 in the cultivating region B in the shell 11, another humidity sensor 73 is inserted in the control region A, and another humidity sensor 73 is supported on the external face of the control region A. Thus, values of humidity in the control region A and the cultivating region B and out of the shell 11 are detected.

Referring to FIG. 10, preferably, an air sensor 74 is inserted in the cultivating region B in the shell 11, another air sensor 74 is inserted in the control region A, and another air sensor 74 is supported on the external face of the shell 11. Thus, air quality such as carbon dioxide concentration, particulate matter concentration in the control region A and the cultivating region B and out of the shell 11 is detected.

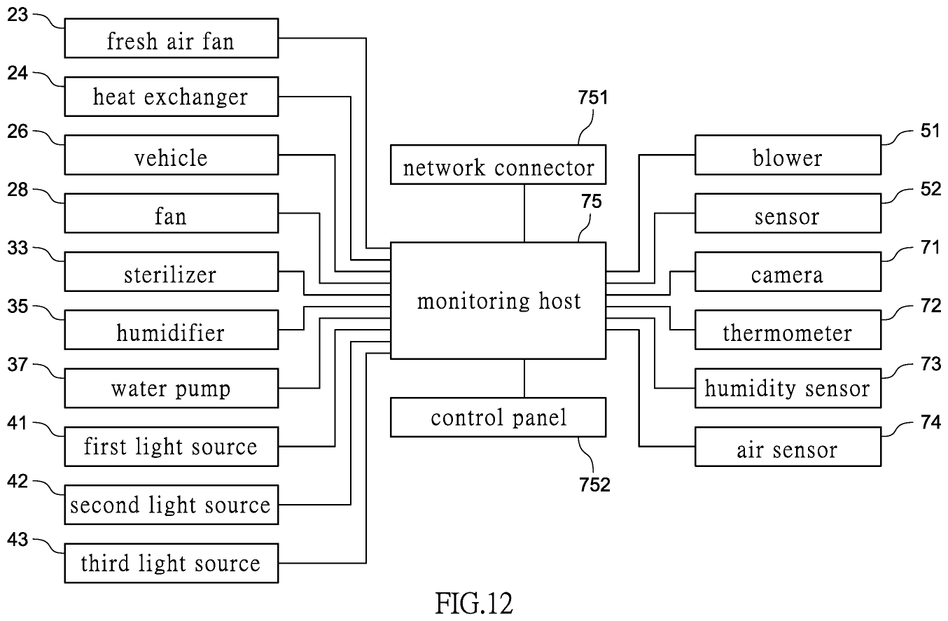

Referring to FIGS. 8 and 12, the monitoring host 75 is electrically connected to the cameras 71, the thermometers 72, the humidity sensors 73, the air sensors 74, the fresh air fan 23, the heat exchanger 24, the sterilizer 33, the humidifier 35, the water pump 37, the first light source 41, the second light source 42, the blower 51 and the sensor 52.

The monitoring host 75 includes a network connector 751 and a control panel 752. The network connector 751 is used for connection to a network in a wireless manner or via a cable to transmit data. With the network connector 751, a user monitors the values of air quality, temperature, humidity and time of irradiation in the cultivating region B. Preferably, a cable network can be Ethernet, the Internet, the cable television network (“CATV”), the public switched telephone network (“PSTN”). A wireless network can be a mobile phone network (4G or 5G) or a Wi-Fi network.

The control panel 752 is operable by the user to enter data. In addition, the control panel 752 shows data to the user.

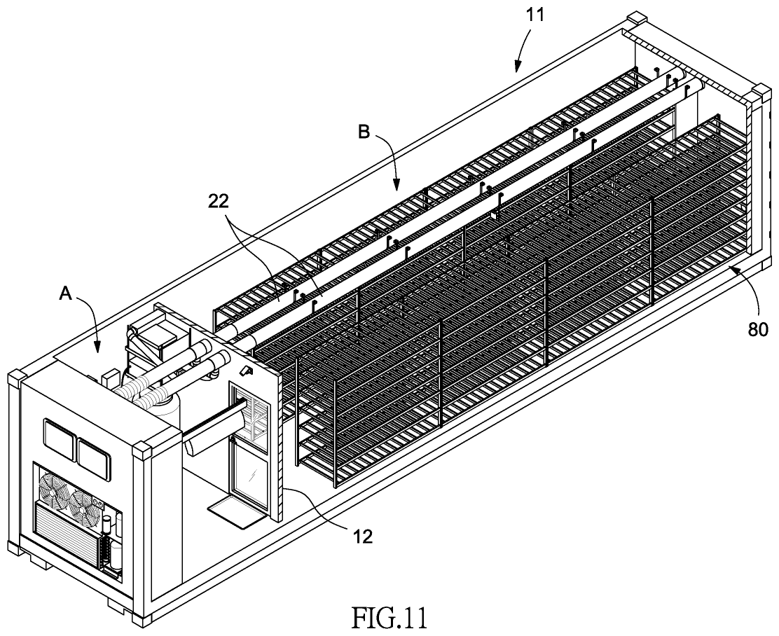

Referring to FIG. 11, an optional shelf 80 is inserted in the cultivating region B in the shell 11 and supported on the horizontal plate 155 (or the flower of the shell 11). Plants or mushrooms (not shown) can be supported and cultivated on the shelf 80. The shelf 80 can be omitted if it is not needed.

The configuration of the cultivating apparatus has been described. The operation of the cultivating apparatus will be discussed.

Referring to FIGS. 3 through 12, plants or mushrooms (not shown) are supported and cultivated on the shelf 80, which is inserted in the cultivating region B. Based on the natures and the curves of the growth of the plants or mushrooms, the monitoring host 75 is used to set the values of the air quality, temperature, humidity and irradiation in the cultivating region B. Thus, the cultivating region B provides an optimal environment for the growth of the plants or mushrooms. Alternatively, the cultivating region B can adjust the period of the growth of the plants or mushrooms based on demands from the market.

For example, firstly, according to the value of humidity detected by the humidity sensor 73, the monitoring host 75 instructs the water pump 37 of the humidifying mechanism to pump water into the cultivating region B from the water tank 31 through the humidifying pipe 34. Thus, the humidity in the cultivating region B is adjusted.

Secondly, based on the value of temperature detected by the therometer 72 and/or the value(s) detected by the air sensor 74, the monitoring host 75 instructs the fresh air fan 23 and the heat exchanger 24 of the fresh air supply to transmit fresh air into the cultivating region B from the exterior of the shell 11 via the air filter 21 and the fresh air pipes 22. Thus, the temperature and air quality in the cultivating region B are retained. A difference in the air pressure due to the transmission of the fresh air into the cultivating region B via the fresh air pipes 22 makes air go to the exterior of the shell 11 from the cultivating region B via the apertures 143 in the front doors 142 and 144. Therefore, the air pressure in the cultivating region B and the air pressure in the exterior of the shell 11 balanced, and the change of air and the regulation of the temperature, humidity and air quality are achieved.

Thirdly, actuated by the sensor 52, the monitoring host 75 instructs the blower 51 to direct wind to the lateral entrance 112 in a direction toward the exterior of the shell 11.

Moreover, during the growth of the plants or mushrooms, the monitoring host 75 is used to observe the growth of the plants or mushrooms and adjust the temperature, humidity and air quality and irradiation in the cultivating region B to make sure that the plants or mushrooms grow at a desired rate.

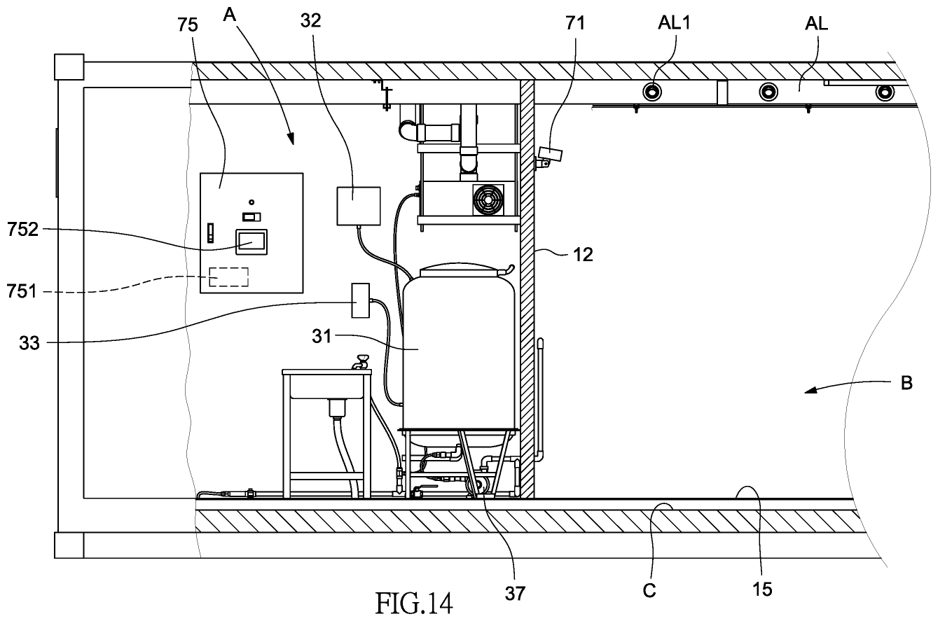

Referring to FIGS. 12 through 15, there is shown a cultivating apparatus according to a second embodiment of the present invention. The second embodiment is like the first embodiment except for several features.

Firstly, an air-conditioning pipe AL is used instead of the fresh air pipes 22 and the humidifying pipe 34. The air-conditioning pipe AL is a combination of the fresh air pipes 22 with the humidifying pipe 34. The air-conditioning pipe AL is inserted in the shell 11. The air-conditioning pipe AL includes a portion in the control region A and another portion in the cultivating region B. The air-conditioning pipe AL is connected to the humidifier 35, the fresh air fan 23 and the heat exchanger 24. Preferably, the air-conditioning pipe AL includes several vents AL1 in a side. Air goes out of the air-conditioning pipe AL via the vents AL1.

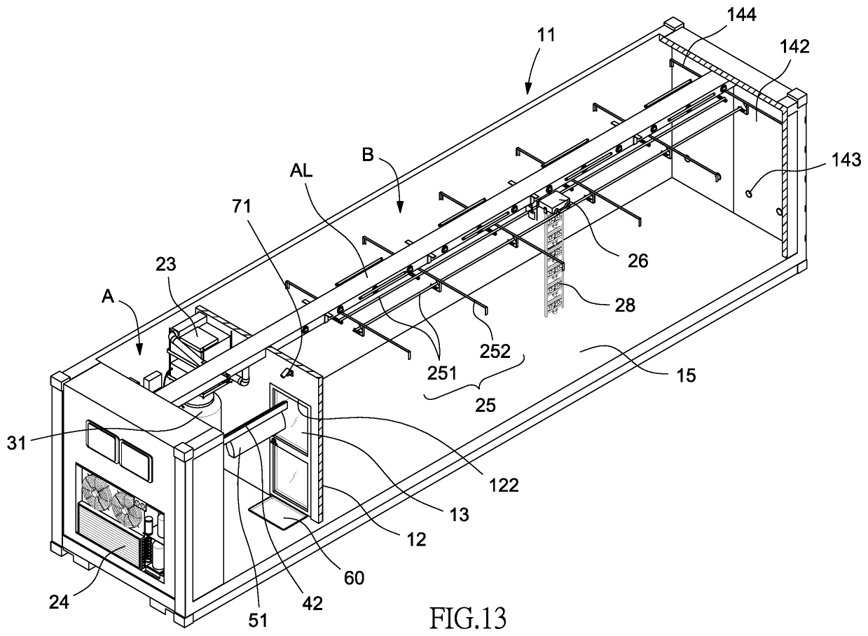

Secondly, referring to FIGS. 13, 15 and 16, the cultivating apparatus further includes a self-moving blowing mechanism in the cultivating region B. The self-moving blowing mechanism includes a rack 25, a vehicle 26, a frame 27 and several fans 28.

The rack 25 includes track 251 and crossbars 252. Each of the crossbars 252 includes two ends connected to the lateral walls of the shell 11. The tracks 251 are supported on the crossbars 252. That is, the tracks 251 are hung on the crossbars 252 in the shell 11.

The vehicle 26 is electrically connected to the monitoring host 75. The vehicle 26 is supported on the tracks 251 of the rack 25. The vehicle 26 is movable to and fro along the tracks 251.

The frame 27 is connected to the vehicle 26 at an upper end. Preferably, a caster (not numbered) is connected to a lower end of the frame 27.

The fans 28 are supported on the frame 27. The fans 28 are electrically connected to the monitoring host 75. The fans 28 are used to blow air to the plants or mushrooms.

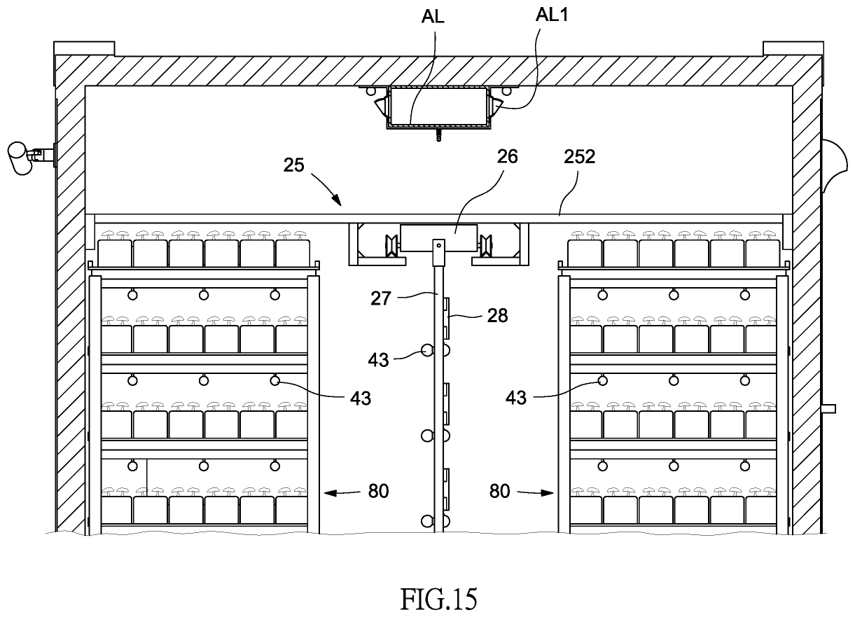

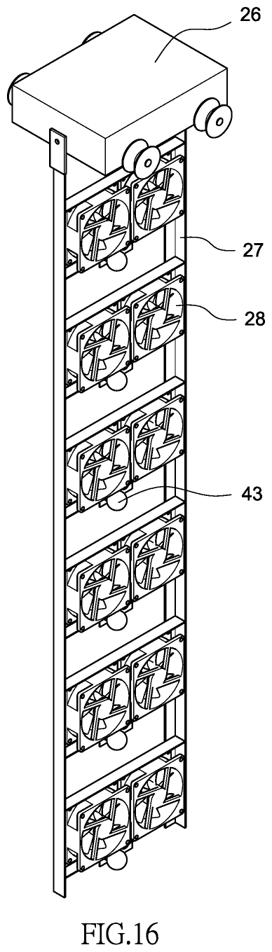

Thirdly, referring to FIGS. 15 and 16, the illuminating mechanism further includes at least one third light source 43 electrically connected to the monitoring host 75. Preferably, several third light sources 43 are used to cast third light on shelfs 80 and the frame 27, respectively. The third light is good for the growth of the plants or mushrooms.

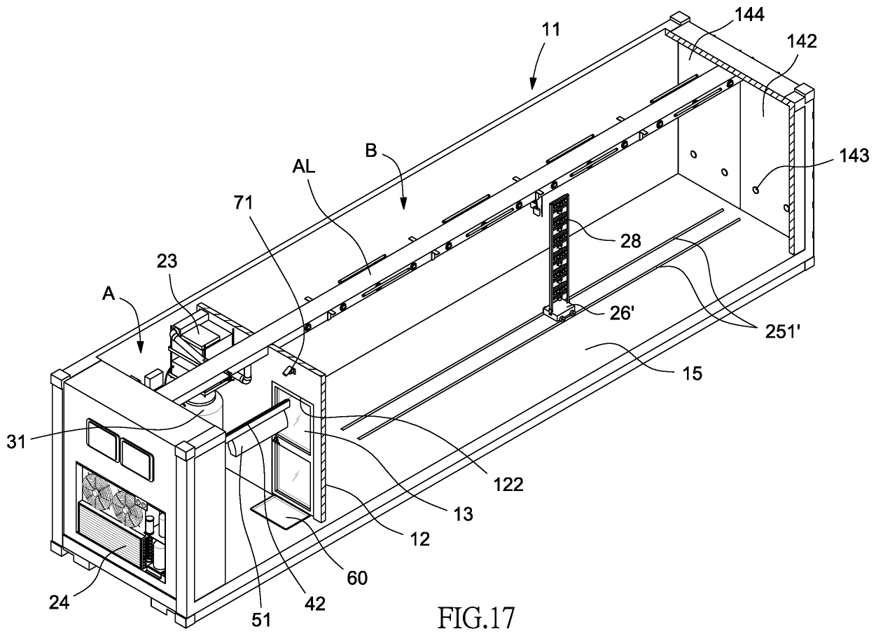

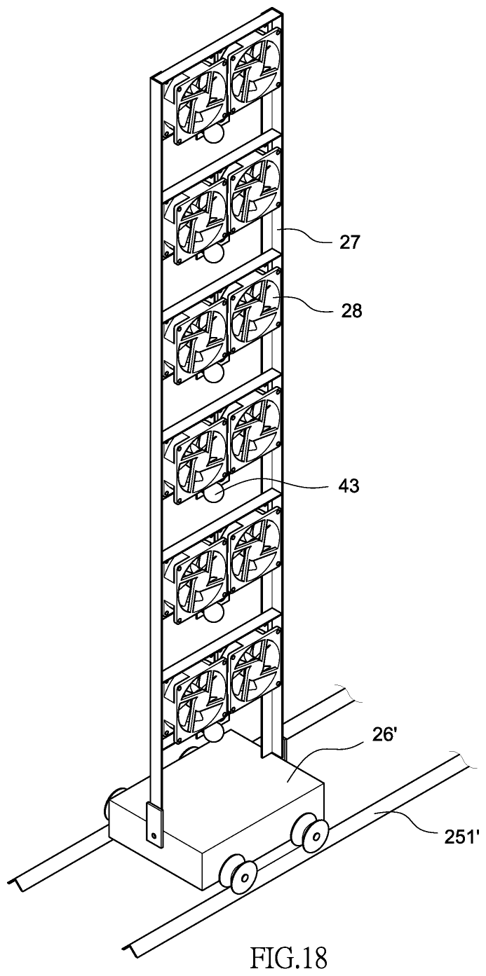

Referring to FIGS. 17 and 18, the cultivating apparatus includes an additional self-moving blowing mechanism in the cultivating region B according to a third embodiment of the present invention. The third embodiment is like the second embodiment except that the self-moving blowing mechanism includes tracks 251′ and a vehicle 26′ instead of the tracks 25 and the vehicle 26.

The tracks 251′ are supported on the horizontal plate 15 (or the floor of the shell 11) in the cultivating region B.

The vehicle 26′ is supported on the tracks 251′. The vehicle 26′ is electrically connected to the monitoring host 75. Thus, the vehicle 26′ is movable to and fro along the tracks 251′.

The frame 27 is carried on the vehicle 26′.

The present invention has been described via the illustration of the embodiments. Those skilled in the art can derive variations from the embodiments without departing from the scope of the present invention. Therefore, the embodiments shall not limit the scope of the present invention defined in the claims.

1. A cultivating apparatus comprising:
a carrier (10) comprising:
a shell (11);
a partition (12) inserted in the shell (11) to divide a space in the shell (11) into a control region (A) and a cultivating region (B);
a partition door (13) pivotally connected to the partition (12) and operable to open or cut communication of the control region (A) with the cultivating region (B);
a front door (142, 144) pivotally connected to a front wall of the shell (11) and operable to open or cut communication of the cultivating region (B) with exterior of the shell (11); and
a lateral door (146) pivotally connected to a lateral wall of the shell (11) and operable to open or cut communication of the control region (A) with the exterior of the shell (11);
a fresh air supply comprising:
an air filter (21) supported on a lateral wall of the shell (11) so that the exterior of the shell (11) is in communication with the control region (A) via the air filter (21);
a fresh air fan (23) in communication with the air filter (21) at an end and in communication with the cultivating region at another end and operable to transmit fresh air into the cultivating region (B) from the exterior of the shell (11); and
a heat exchanger (24) supported on the shell (11) and operable to exchange heat with the cultivating region (B);
a humidifying mechanism comprising:
a water tank (31) inserted in the control region (A) in the shell (11);
a humidifier (35) inserted in the control region (A) in the shell (11), in communication with the water tank (31) at an end, in communication with the cultivating region (B) at another end, and operable to provide humidifying air;
sprinklers (36) inserted in the cultivating region (B) in the shell (11); and
a water pump (37) inserted in the control region (A) in the shell (11), in communication with the water tank (31) at an end, and in communication with the sprinklers (36) at another end;
an illuminating mechanism comprising at least one first light source (41) inserted in the cultivating region (B) in the shell (11) and operable to emit first light; and
a controlling mechanism comprising:
at least one thermometer (72) inserted in the cultivating region (B) in the shell (11), and operable to detect a value of temperature in the cultivating region (B);
at least one humidity sensor (73) inserted in the cultivating region (B) in the shell (11), and operable to detect a value of humidity in the cultivating region (B);
at least one air sensor (74) inserted in the cultivating region (B) in the shell (11), and operable to detect a value of air quality in the cultivating region (B); and
a monitoring host (75) electrically connected to the therometer (72), the humidity sensor (73), the air sensor (74), the fresh air fan (23), the heat exchanger (24), the water pump (37) and the first light source (41), and operable to actuate the water pump (37), the fresh air fan (23), the heat exchanger (24), the humidifier (35) and the first light source (41) according to predetermined values of the temperature, humidity and air quality.

2. The cultivating apparatus according to claim 1, wherein the fresh air supply further comprises a fresh air pipe (22) comprising a first portion in the control region (A), a second portion in the cultivating region (B), and orifices (221) in and along the second portion of the fresh air pipe (22), wherein the fresh air pipe (22) is connected to the fresh air fan (23) and the heat exchanger (24).

3. The cultivating apparatus according to claim 1, wherein the humidifying mechanism further comprises a humidifying pipe (34) comprising a first portion in the control region (A), a second portion in the cultivating region (B), and humidifying bores (341) in the second portion of the humidifying pipe (34), wherein the humidifying pipe (34) is connected to the humidifier (35).

4. The cultivating apparatus according to claim 1, further comprising an air-conditioning pipe (AL) comprising a first portion in the control region (A), a second portion in the cultivating region (B), and vents (AL1) in the second portion of the air-conditioning pipe (AL), wherein the air-conditioning pipe (AL) is connected to the humidifier (35), the fresh air fan (23) and the heat exchanger (24).

5. The cultivating apparatus according to claim 1, wherein the humidifying mechanism further comprises a water filter (32) inserted in the control region (A) in the shell (11), and connected to the water tank (31) and an external water source.

6. The cultivating apparatus according to claim 1, wherein the humidifying mechanism further comprises a sterilizer (33) connected to the water tank (31) and electrically connected to the monitoring host (75).

7. The cultivating apparatus according to claim 1, further comprising a blower mechanism comprising:
a blower (51) inserted in the shell (11) corresponding to the lateral door (146) and electrically connected to the monitoring host (75); and
a sensor (52) inserted in the shell (11) corresponding to the lateral door (146) and electrically connected to the monitoring host (75).

8. The cultivating apparatus according to claim 1, further comprising a sterilizing pool (60) inserted in the control region (A) in the shell (11) corresponding to the partition door (13).

9. The cultivating apparatus according to claim 1, wherein the controlling mechanism further comprises at least one camera (71) inserted in the shell (11) and electrically connected to the monitoring host (75).

10. The cultivating apparatus according to claim 1, wherein the front door (142, 144) comprises at least one aperture (143).

11. The cultivating apparatus according to claim 1, further comprising a self-moving blowing mechanism comprising:
a rack (25) comprising crossbars (252) inserted in the cultivating region (B) in the shell (11) and a track (251) supported on the crossbars (252);
a vehicle (26) movable along the track (251) and electrically connected to the monitoring host (75);
a frame (27) comprising an upper end connected to the vehicle (26); and
fans (28) supported on the frame (27) and electrically connected to the monitoring host (75).

12. The cultivating apparatus according to claim 1, further comprising a self-moving blowing mechanism comprising:
a track (251′) supported on a lower portion of the shell (11);
a vehicle (26′) movable along the track (251′) and electrically connected to the monitoring host (75);
a frame (27) comprising a lower end connected to the vehicle (26′); and
fans (28) supported on the frame (27) and electrically connected to the monitoring host (75).

13. The cultivating apparatus according to claim 1, wherein the shell (11) comprises a floor, and the carrier (10) further comprises a horizontal plate (15) extending in the shell (11) to provide a drain region (C) between the floor of the shell (11) and the horizontal plate (15).

14. The cultivating apparatus according to claim 13, wherein the horizontal plate (15) comprises sinkholes (151) in the cultivating region (B) so that the drain region (C) is in communication with the cultivating region (B) via the sinkholes (151).

15. The cultivating apparatus according to claim 13, wherein the humidifying mechanism further comprises a hose (38) in communication with the water pump (37) at an end and in communication with the drain region (C) at another end.

16. The cultivating apparatus according to claim 1, wherein the illuminating mechanism further comprises at least one second light source (42) inserted in the control region (A) in the shell (11) and operable to emit second light.

17. The cultivating apparatus according to claim 16, wherein the first light is identical to the second light in spectrum.

18. The cultivating apparatus according to claim 16, wherein the first light is different from the second light in spectrum.

19. The cultivating apparatus according to claim 1, wherein the cultivating region (B) further comprises at least one shelf (80).

20. The cultivating apparatus according to claim 19, wherein the illuminating mechanism further comprises at least one third light source for casting third light onto the shelf (80).
